(19) United States
(12) Patent Application Publication
(10) Pub. No.: US 2023/0033280 A1
(43) Pub. Date: Feb. 2, 2023

(54) OPERATION INPUT DEVICE

(71) Applicant: MURAKAMI CORPORATION, Shizuoka (JP)

(72) Inventor: Kazuki TAKABAYASHI, Shizuoka (JP)

(73) Assignee: MURAKAMI CORPORATION, Shizuoka (JP)

(21) Appl. No.: 17/759,121

(22) PCT Filed: Dec. 9, 2020
(86) PCT No.: PCT/JP2020/045928

§ 371 Date: Jul. 20, 2022

(30) Foreign Application Priority Data
Feb. 28, 2020 (JP) 2020-034107

(51) Int. Cl. G06F 3/01; H05B 47/125

(52) U.S. Cl. CPC G06F 3/013; H05B 47/125

(57) ABSTRACT

An operation input device according to one embodiment includes: a display device that emits light to display information; an aerial image forming device that reflects the light from the display device a plurality of times to display a display plane with a switch in an air as a virtual image; a sensor that detects a position of a target object approaching the switch; and a determination unit that determines whether or not the switch has been operated, based on the position of the target object detected by the sensor. An eyepoint position where eyes of an operator that operates the switch are located is set in advance. The aerial image forming device is disposed on a straight line connecting the eyepoint position and the display plane.

### TECHNICAL FIELD

The present disclosure relates to an operation input device to which an operation to operate a device is input.

### BACKGROUND ART

In the related art, various operation input devices have been known. Japanese Unexamined Patent Publication No. 2013-4476 discloses an operation switch panel that optically detects a non-contact operation. The operation switch panel is an operation input device that turns on and off a lighting lamp of a washbasin. The operation switch panel includes a smooth operation surface without irregularities, and two operation switches provided on the operation surface. One of the two operation switches is a lighting switch, and the other of the two operation switches is an anti-fog switch.

The operation switch has an operation mark that is three-dimensionally displayed, and a detection region that detects a non-contact operation. The operation mark is displayed floating with respect to the smooth surface, and the amount of floating of the operation mark is set to substantially coincide with the height of the detection region. In the operation switch panel, the corresponding operation switch can be operated in a non-contact manner by operating the operation mark through touching the operation mark with a finger or the like.

The operation switch panel includes a housing, a three-dimensional display sheet, a control substrate, a light-emitting unit, a light-receiving unit, and a reflecting plate. The three-dimensional display sheet forms the smooth surface and seals the housing. The control substrate is disposed inside the housing, and the light-emitting unit and the light-receiving unit are provided on the control substrate. The reflecting plate is provided inside the housing and reflects light from the light-emitting unit. The housing includes a transmission window that transmits light from the reflecting plate to the outside of the housing. The three-dimensional display sheet includes a 3D image sheet on which a 3D original image that is an original picture of the operation mark is printed, and a lenticular lens sheet including a ridge-shaped protrusion.

The control substrate includes a detection control unit that controls the light-emitting unit and the light-receiving unit, an operation detection unit that detects an operation, and a switching control unit that executes an on/off operation corresponding to the operation, as functional components. The detection control unit causes light to be emitted to the outside of the housing via the reflecting plate. The operation detection unit determines that there is an operation, when detecting that a finger or the like is located in the detection region, and outputs an operation detection signal. The switching control unit receives the operation detection signal from the operation detection unit and executes an on/off operation of the lighting lamp or the like when the switching control unit receives the operation detection signal.

### CITATION LIST

### Patent Literature

Patent Literature 1: Japanese Unexamined Patent Publication No. 2013-4476

### SUMMARY OF INVENTION

### Technical Problem

In the operation switch panel described above, the light-emitting unit and the reflecting plate are disposed inside the housing, and the light from the light-emitting unit is reflected by the reflecting plate, transmits through the transmission window of the housing, and is emitted to the outside of the housing. Therefore, since the transmission window that transmits light needs to be formed in the housing, when the 3D original image of the 3D image sheet is viewed as the operation mark, it is assumed that the location of the transmission window is seen as being missing.

In the operation switch panel described above, since the 3D original image that is an original picture is displayed as the operation mark by the 3D image sheet and the lenticular sheets, display contents cannot be easily changed. In the operation switch panel described above, since the original picture of the 3D image sheet is displayed with light from the lenticular sheet, it is assumed that it is difficult for an operator to view the original picture depending on the position of the operator. Further, even when the operator touches the operation mark with a finger, unless the lighting lamp or the like is actually turned on and off, it is not possible to know whether or not the operation has been executed. As described above, since it is difficult for the operator to know whether or not the operation has been executed, there is room for improvement in terms of the ease of operation.

The present disclosure is conceived in view of the above-described problems, and an object of the present disclosure is to provide an operation input device that is easy to view and easy to operate.

### Solution to Problem

An operation input device according to the present disclosure includes: a display device that emits light to display information; an aerial image forming device that reflects the light from the display device a plurality of times to display a display plane with a switch in an air as a virtual image; a sensor that detects a position of a target object approaching the switch; and a determination unit that determines whether or not the switch has been operated, based on the position of the target object detected by the sensor. An eyepoint position where eyes of an operator that operates the switch are located is set in advance. The aerial image forming device is disposed on a straight line connecting the eyepoint position and the display plane.

The operation input device includes the aerial image forming device that displays the display plane with the switch. The aerial image forming device reflects the light from the display device a plurality of times to display the display plane with the switch in the air as a virtual image. Therefore, since the display plane with the switch is displayed floating from the aerial image forming device, the display plane is easily visible. Since the aerial image forming device reflects the light from the display device a plurality of times to display the display plane, the display plane can be easily seen without the display plane seen as being missing. In the operation input device, display contents of the display plane to be displayed by the aerial image forming device can be easily changed by changing information displayed by the display device. Therefore, since the display contents can be easily changed, the display plane can be displayed that is easy to view and easy to operate. In the operation input device, the eyepoint position where the eyes of the operator are located are set in advance, and the aerial image forming device is disposed on the straight line connecting the eyepoint position and the display plane. Since the position of the aerial image forming device is determined based on the eyepoint position and the position of the display plane, it is possible to further improve the visibility and the operability of the display plane.

A length of the display plane in a vertical direction displayed by the aerial image forming device may be shorter than a length of the display plane in a horizontal direction. In this case, the amount of protrusion of the operation input device can be suppressed, and a contribution is made to a reduction in the size of the operation input device.

The aerial image forming device may display the display plane such that a center of the switch is offset from a center of the display plane. In this case, since the switch is displayed on the display plane with the position of the switch biased, a region in which contents other than the switch are displayed can be widely secured on the display plane. Therefore, since various contents other than the switch can be displayed, the display contents of the display plane can be made more substantial.

The operation input device described above may further include notification means for notifying the operator that the switch has been operated, when the determination unit determines that the switch has been operated. In this case, the operator can identify an indication of execution of the operation through a notification of the operation made by the notification means. Therefore, since the operator can recognize that the switch has been operated, the operation input device can be provided that is easier to operate.

The operation input device described above may further include position detection means for detecting a position of the eyes of the operator; and a movable mechanism that moves the display device and the aerial image forming device such that the eyepoint position coincides with the position of the eyes detected by the position detection means. In this case, when an actual position of the eyes of the operator is different from the eyepoint position set in advance, the movable mechanism moves the eyepoint position to the actual position of the eyes of the operator. Therefore, even when the operator views the aerial image forming device from a location offset from the eyepoint position, the eyepoint position is moved to coincide with the actual position of the eyes. As a result, it is possible to provide the operation input device having more improved visibility.

### Advantageous Effects of Invention

According to the present disclosure, it is possible to provide the operation input device that is easy to view and easy to operate.

### BRIEF DESCRIPTION OF DRAWINGS

FIG. 1 is a perspective view illustrating an exemplary toilet in which an operation input device according to an embodiment is installed.

FIG. 2 is a perspective view illustrating a state where the operation input device of FIG. 1 displays a display plane with switches.

FIG. 3 is a vertical sectional view of the operation input device of FIG. 1.

FIG. 4 is a block diagram illustrating functions of the operation input device of FIG. 1.

FIG. 5 is a vertical sectional view illustrating a positional relationship between an eyepoint position, a display plane, and an aerial image forming device of the operation input device of FIG. 1.

FIG. 6 is a vertical sectional view illustrating an operation input device according to a modification example.

### DESCRIPTION OF EMBODIMENTS

Hereinafter, an embodiment of an operation input device according to the present disclosure will be described with reference to the drawings. In the description of the drawings, the same or corresponding elements are denoted by the same reference signs, and a duplicated description will be appropriately omitted. The depiction of the drawings may be partially simplified or exaggerated for the ease of understanding, and dimensions, angles, and the like are not limited to those described in the drawings.

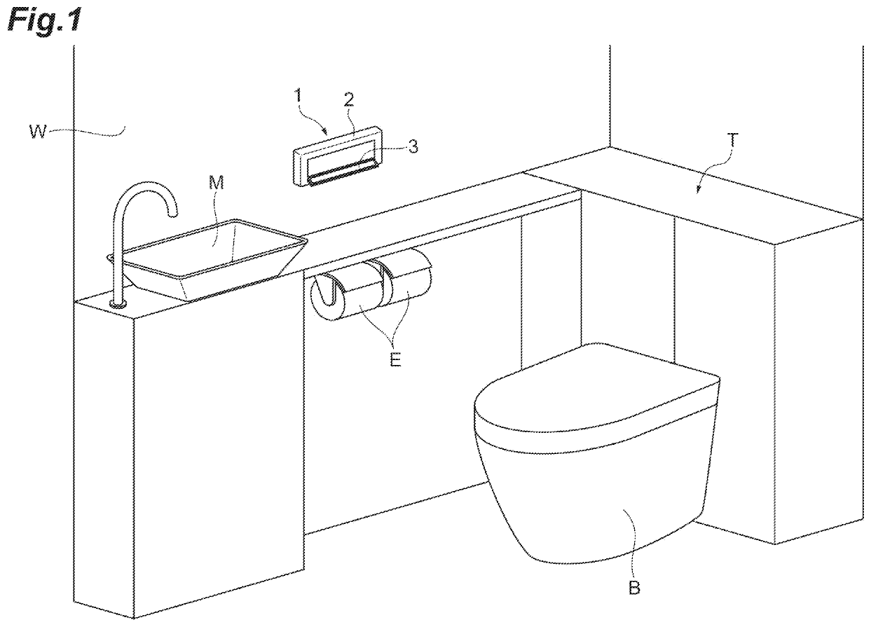

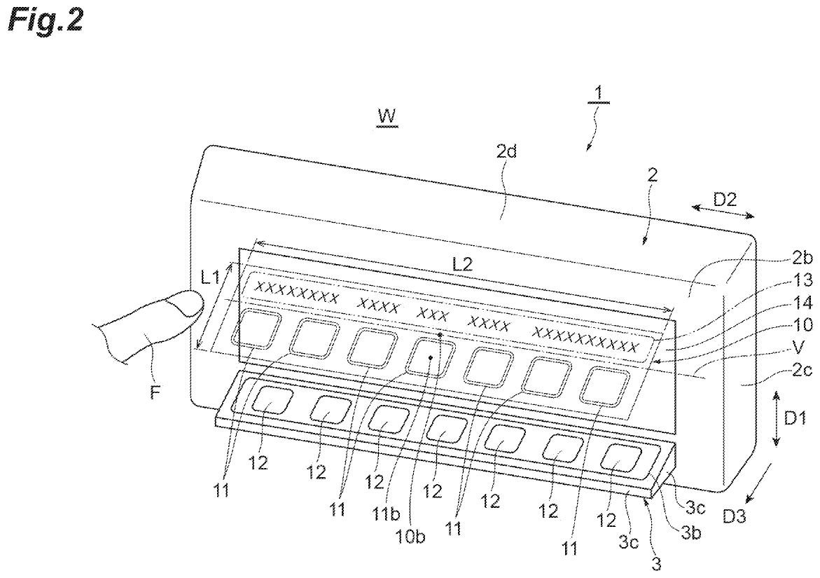

FIG. 1 is a perspective view illustrating an operation input device 1 according to the present embodiment. FIG. 2 is a perspective view illustrating a state where the operation input device 1 displays a display plane 10 with switches 11 in the air. For example, the operation input device 1 is provided in a toilet T, and the switches 11 of the display plane 10 are switches that operate each part of the toilet T. The display plane 10 with the switches 11 are displayed floating in the air. Namely, the display plane 10 with the switches 11 is displayed in the air as a virtual image. As a result, an operator does not have to directly touch buttons or the like, so that the operator can hygienically operate each part of the toilet T.

As one example, the toilet T includes a toilet bowl B and a wall W adjacent to the toilet bowl B. For example, the wall W is provided on a right side when viewed from the operator seated in the toilet bowl B.

The operation input device 1 and a toilet paper E are fixed to the exemplary wall W, and the exemplary wall W may be provided with a washbasin M.

The toilet bowl B is provided with, for example, a washlet (registered trademark), and the washlet of the toilet T can be operated from the switches 11 of the display plane 10. For example, the display plane 10 includes a plurality of the switches 11. The operator can operate each part of the washlet by operating the plurality of switches 11.

As one example, toilet bowl washing (corresponding to, for example, a “flush” button) may be performed by operating the switch 11. Further, the washbasin M may be operable by the switch 11. As described above, each part of the toilet T can be operated by the switches 11 displayed in the air.

The operation input device 1 is fixed to, for example, the wall W. The operation input device 1 may be embedded in the wall W or may be attachable to and detachable from the wall W. The exemplary operation input device 1 includes a housing 2 and a protrusion portion 3 protruding from a lower portion of the housing 2. A plurality of sensors 12 that detect a target object F approaching the switches 11 are embedded in the protrusion portion 3.

In the present disclosure, the “target object” represents an object that operates the switch 11 to operate a device, and represents, for example, a finger of the operator. The sensors 12 are provided to correspond to the switches 11. The switches 11 are provided above and obliquely to the sensors 12. As one example, the number of the switches 11 and of the sensors 12 is 7.

The display plane 10 is displayed to face obliquely upward with respect to both an up-down direction D1 of the operation input device 1 and a protruding direction D3 from the wall W. Accordingly, the display plane 10 is easily visible to the operator. For example, since the display plane 10 is displayed with light, the display plane 10 is easily visible regardless of the ambient brightness. The display plane 10 has, for example, a shape extending long in a left-right direction D2.

As one example, the display plane 10 has a rectangular shape. A length L1 of the display plane 10 in a vertical direction is shorter than a length L2 of the display plane 10 in a horizontal direction. When the aspect ratio of the length L1 and the length L2 is 1: X (X is a real number), for example, the value of X is from 2 to 10. A lower limit of the value of X may be 3, and an upper limit of the value of X may be 5, 6, 7, 8, or 9.

As one example, the value of X is 4 and the aspect ratio of the length L1 and the length L2 may be 1: 4. The switch 11 has, for example, a rectangular shape. As one example, the switch 11 may have a square shape. The length of one side of the switch 11 is, for example, from 18 mm to 24 mm. However, the shape and the size of the switch 11 can be appropriately changed.

The display plane 10 may display information other than the plurality of switches 11. For example, the display plane 10 may include the plurality of switches 11 and character information 13. As one example, the character information 13 may include at least one of date information, time information, atmospheric temperature information, temperature information, and barometric pressure information.

For example, the plurality of switches 11 are displayed on the display plane 10 on a lower side of the display plane 10 to be arranged in the horizontal direction. The character information 13 may be displayed above the plurality of switches 11. The switch 11 may be disposed such that a center 11b of the switch 11 is located at a position offset from a center 10b of the display plane 10. In the present embodiment, the plurality of switches 11 each are displayed at positions offset from a reference line V passing through the center 10b and extending in a longitudinal direction (horizontal direction) of the display plane 10.

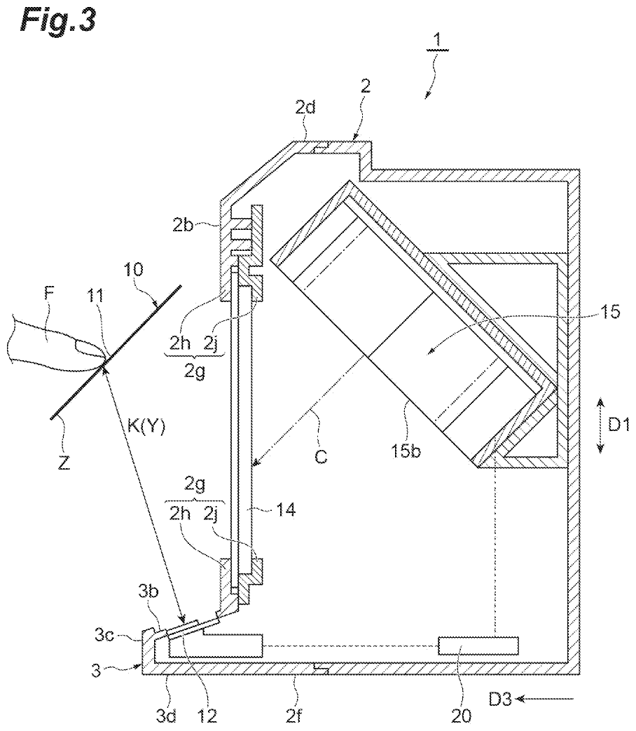

FIG. 3 is a vertical sectional view illustrating the exemplary housing 2 and the exemplary protrusion portion 3. As illustrated in FIGS. 2 and 3, the housing 2 has, for example, a box shape extending horizontally. As one example, the housing 2 has a front surface 2b, a side surface 2c, an upper surface 2d, and a lower surface 2f The front surface 2b extends in the up-down direction D1 and in the left-right direction D2 in a state where the housing 2 is attached to the wall W, and a pair of the side surfaces 2c extend in the up-down direction D1 and in the protruding direction D3 from the wall W. The upper surface 2d extends in the left-right direction D2 and in the protruding direction D3, and the lower surface 2f faces opposite the upper surface 2d.

The protrusion portion 3 has, for example, a rectangular shape. As one example, the protrusion portion 3 has a main surface 3b protruding from a lower side of the front surface 2b and facing upward, an end surface 3c facing the left-right direction D2 or the protruding direction D3, and a back surface 3d facing opposite the main surface 3b. As described above, the sensors 12 are built-in in the protrusion portion 3. Accordingly, the target object F can be easily detected by the sensors 12.

The operation input device 1 includes an aerial image forming device 14 that displays the display plane 10 with the switches 11, a display device 15 disposed inside the housing 2, and a control unit 20. The aerial image forming device 14 and the display device 15 correspond to a virtual image display unit that displays the display plane 10 in the air as a virtual image. The aerial image forming device 14 is fixed to, for example, a support portion 2g located on an inner side of the front surface 2b of the housing 2.

The support portion 2g includes, for example, a pair of first plate portions 2h forming the front surface 2b of the housing 2, and a pair of second plate portions 2j fixed to an inner side of the first plate portions 2h of the housing 2. As one example, the housing 2 includes a pair of the upper and lower support portions 2g. The aerial image forming device 14 is fixed to the housing 2 in a state where the aerial image forming device 14 is sandwiched between the first plate portions 2h and the second plate portions 2j.

The aerial image forming device 14 has, for example, an oblong shape having long sides extending in the left-right direction D2 and short sides extending in the up-down direction D1. Each of one long side and the other long side of the aerial image forming device 14 is sandwiched between the first plate portion 2h and the second plate portion 2j. The display device 15 is disposed obliquely with respect to the aerial image forming device 14.

As one example, the display device 15 is a liquid crystal display (LCD). The display device 15 is disposed above and obliquely to the aerial image forming device 14 inside the housing 2. The display device 15 includes a screen 15b that displays an image. For example, the screen 15b emits light C obliquely downward toward the aerial image forming device 14, as an image. The aerial image forming device 14 reflects the light C from the display device 15 inside the housing 2 a plurality of times (for example, two times) to form the display plane 10 with the switches 11 in a space in front of the aerial image forming device 14 when viewed from the operator.

For example, the sensors 12 may be exposed on the main surface 3b of the protrusion portion 3. As one example, the sensor 12 is a depth sensor. For example, the sensor 12 is provided on an imaginary straight line extending from the switch 11, namely, at a front position with respect to the switch 11 that is a virtual image. The sensor 12 acquires distance image data including information of the position (two-dimensional position) of the target object F on a plane perpendicular to the imaginary straight line and information of a distance K from the sensor 12 to the target object F. For example, the sensor 12 outputs the acquired distance image data to the control unit 20 at a predetermined period (for example, 1/30 seconds).

As a specific example, the sensor 12 irradiates each point on an object existing in an imaging region including the target object F, with light rays (or infrared rays) and receives light rays reflected from each point on the object. The sensor 12 measures a distance between the sensor 12 and each point on the object based on the received light rays, and outputs the measured distance for each pixel. The distance between the sensor 12 and each point on the object may be measured, for example, by the light coding method.

In the light coding method, the sensor 12 irradiates each point on the object existing in the imaging region including the target object F, with light rays in a random dot pattern. The sensor 12 measures a distance between the sensor 12 and each point on the object by receiving light rays reflected from each point on the object and detecting distortion of the pattern of the reflected light rays. The sensor 12 detects information of the two-dimensional position of each point on the object and information of the distance from the sensor 12 to each point on the object, as a plurality of pixels, and outputs the plurality of detected pixels to the control unit 20.

The control unit 20 can communicate with the sensors 12 and the display device 15. The control unit 20 includes, for example, a central processing unit (CPU) that executes a program, a storage unit including a read only memory (ROM) and a random access memory (RAM), an input and output unit, and a driver. Each function of the control unit 20 is executed by operating the input and output unit based on control of CPU, and performing reading and writing data from and in the storage unit. The form and the disposition place of the control unit 20 are not particularly limited.

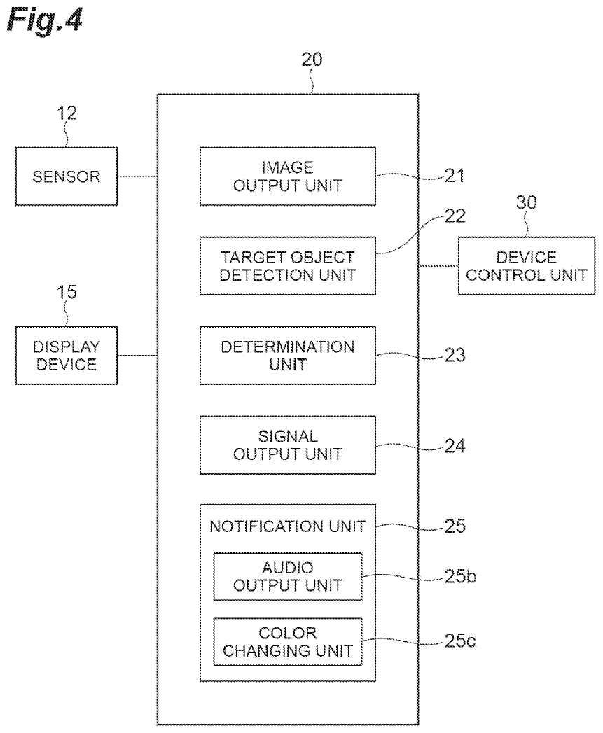

FIG. 4 is a functional block diagram of the control unit 20. As illustrated in FIGS. 3 and 4, the control unit 20 includes an image output unit 21, a target object detection unit 22, a determination unit 23, a signal output unit 24, and a notification unit 25 as functional components. The image output unit 21 outputs image data of an image to be displayed on the display device 15, to the display device 15. The display device 15 can display various types of images based on the image data from the image output unit 21.

The target object detection unit 22 detects the target object F based on the distance image data output from the sensor 12. When the target object F is detected, the target object detection unit 22 outputs position data indicating the position of the target object F, to the determination unit 23. The determination unit 23 determines whether or not the switch 11 is pressed by the target object F, based on the position data output from the target object detection unit 22.

The determination unit 23 determines whether or not the distance K between the sensor 12 and the target object F is a threshold value Y or less. When it is determined that the distance K is the threshold value Y or less, the determination unit 23 determines that the target object F has reached an imaginary press determination plane Z and the switch 11 has been pressed. For example, when it is determined that the switch 11 has been pressed, the determination unit 23 generates an operation signal indicating that the operation of the switch 11 has been performed.

The press determination plane Z is an imaginary plane formed at a site where the distance from the sensors 12 is constant. For example, the press determination plane Z is provided at a position close to the switch 11. The position of the press determination plane Z may coincide with the position of the switch 11 or may be a position separated from the switch 11 by a predetermined distance. In the present embodiment, the position of the press determination plane Z coincides with the position of the switch 11.

When the determination unit 23 determines that the switch 11 has been pressed, the notification unit 25 receives the operation signal from the determination unit 23. Namely, the notification unit 25 is notification means for notifying the operator that the switch 11 has been operated, when the determination unit 23 determines that the switch 11 has been operated. The notification unit 25 includes, for example, an audio output unit 25b and a color changing unit 25c.

As one example, the audio output unit 25b is a speaker and outputs audio when the operation signal is received from the determination unit 23. When the operator hears the audio from the audio output unit 25b, the operator can identify an indication of operation of the switch 11. For example, when the operation signal is received from the determination unit 23, the color changing unit 25c generates a color change signal and outputs the color change signal to the display device 15.

When the display device 15 receives the color change signal from the color changing unit 25c, for example, the display device 15 changes a color of the switch 11 pressed by the operator. When the operator views a change in the color of the switch 11, the operator can identify an indication of operation of the switch 11. When the display device 15 receives the color change signal from the color changing unit 25c, the display device 15 may change a color of a location other than the switch 11.

Since the notification unit 25 described above is provided, the operator can identify an indication of operation of the switch 11. However, in the notification unit 25, at least one of the audio output unit 25b and the color changing unit 25c may be omitted. The notification unit 25 may notify the operator that the switch 11 has been operated, in a mode different from an audio output by the audio output unit 25b or from a color change by the color changing unit 25c.

When the determination unit 23 determines that a press operation of the switch 11 is performed, the signal output unit 24 generates a control signal based on the press operation of the switch 11. The signal output unit 24 outputs the generated control signal to a device control unit 30 of a device outside the operation input device 1. The device control unit 30 that has received the control signal causes the device to operate.

For example, the device control unit 30 may cause at least one of the toilet bowl B with a washlet (refer to FIG. 1), each part of the washlet, and the washbasin M to operate. As one example, the device control unit 30 may cause the toilet bowl B to perform toilet bowl washing when the switch 11 corresponding to the toilet bowl washing is pressed. As described above, in the operation input device 1, each part of the toilet T can be operated by operating the switches 11 displayed as a virtual image. Therefore, since it is not necessary to directly (physically) press buttons or the like to operate each part of the toilet T, a hygienic operation can be realized.

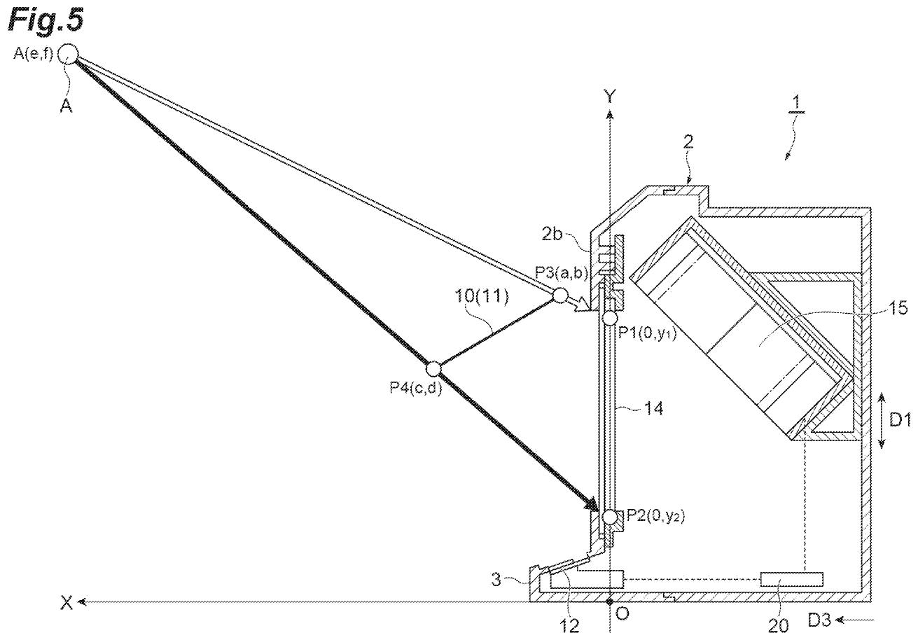

FIG. 5 is a view illustrating a positional relationship between the aerial image forming device 14, the display plane 10 with the switches 11, and an eyepoint position A of the operation input device 1. As illustrated in FIGS. 4 and 5, in the present embodiment, the eyepoint position A where the eyes of the operator that operates the switch 11 of the display plane 10 are assumed to be located is set in advance. The position of the display plane 10 and of the aerial image forming device 14 is determined based on the eyepoint position A.

The aerial image forming device 14 is disposed on a straight line connecting the eyepoint position A and the display plane 10. The aerial image forming device 14 is located on a straight extension line extending from the eyepoint position A to an arbitrary location on the display plane 10. Therefore, the display plane 10 that is easy for the operator to view can be displayed.

The eyepoint position A indicates, for example, a location where the eyes of the operator seated in the toilet bowl B of the toilet T are assumed to be located. As one example, the eyepoint position A is provided at the position of a height obtained by adding a sitting height of an average adult from an upper surface of a toilet seat of the toilet bowl B. When a point located below the front surface 2b of the housing 2 at a lower end of the housing 2 is an origin O, an X axis extending from the origin O in the protruding direction D3 and a Y axis extending upward from the origin O are determined, and the XY coordinates of the eyepoint position A are a point A (e,f), the position of the aerial image forming device 14 and the position of the display plane 10 are determined as follows.

Under the above conditions, the XY coordinates of an upper end of the aerial image forming device 14 are a point P1 (0,y₁), the XY coordinates of a lower end of the aerial image forming device 14 are a point P2 (0,y₂), the XY coordinates of an upper end of the display plane 10 are a point P3 (a,b), and the XY coordinates of a lower end of the display plane 10 are a point P4 (c,d). When a vector from the point A to the point P3 is α and a vector from the point A to the point P1 is α′, since α and α′ are parallel to each other (located on the same straight line), the following Equation (1) is established.

[Equation 1]

(e−α):(f−b)=(e−0):(f−y₁) (1)

When Equation (1) is solved for y₁, the following Equation (2) is obtained.

$$\begin{matrix}[ Equation 2 ] & \\ {y}_{1} = f - \frac{e ( f - b )}{e - a} & ( 2 )\end{matrix}$$

When a vector from the point A to the point P4 is β and a vector from the point A to the point P2 is β′, since β and β′ are parallel to each other (located on the same straight line), the following Equation (3) is established.

[Equation 3]

(e−c):(f−d)=(e−0):(f−y₂) (3)

When Equation (3) is solved for y₂, the following Equation (4) is obtained.

$$\begin{matrix}[ Equation 4 ] & \\ {y}_{2} = f - \frac{e ( f - d )}{e - c} & ( 4 )\end{matrix}$$

From Equation (2) and Equation (4), the Y coordinate of each of the point P1 (0,y₁) of the upper end of the aerial image forming device 14 and the point P2 (0,y₂) of the lower end of the aerial image forming device 14 is expressed by the following Equation (5).

$$\begin{matrix}[ Equation 5 ] & \\ \begin{matrix}{y}_{1} = f - \frac{e ( f - b )}{e - a} & {y}_{2} = f - \frac{e ( f - d )}{e - c}\end{matrix} & ( 5 )\end{matrix}$$

The length of the aerial image forming device 14 in the up-down direction D1 is expressed by the following Equation (6).

$$\begin{matrix}[ Equation 6 ] & \\ {y}_{1} - {y}_{2} = \frac{e ( f - d )}{e - c} - \frac{e ( f - b )}{e - a} & ( 6 )\end{matrix}$$

As described above, the length of the aerial image forming device 14 in the up-down direction D1 can be obtained from the point A (e,f) that is the eyepoint position A, the point P3 (a,b) that is the upper end of the display plane 10, and the point P4 (c,d) that is the lower end of the display plane 10. The disposition of the aerial image forming device 14 which takes the eyepoint position A into consideration can be realized by obtaining the length of the aerial image forming device 14 in the up-down direction D1 as described above. Therefore, it is possible to further improve the visibility of the display plane 10.

Next, actions and effects of the operation input device 1 according to the present embodiment will be described in detail. The operation input device 1 includes the aerial image forming device 14 that displays the display plane 10 with the switches 11. The aerial image forming device 14 reflects the light C from the display device 15 a plurality of times to display the display plane 10 with the switches 11 in the air as a virtual image.

Therefore, as illustrated in FIG. 2, since the display plane 10 with the switches 11 is displayed floating from the aerial image forming device 14, the display plane 10 is easily visible. Since the aerial image forming device 14 reflects the light C from the display device 15 a plurality of times to display the display plane 10, the display plane 10 can be easily seen without the display plane 10 seen as being missing.

In the operation input device 1, display contents of the display plane 10 to be displayed by the aerial image forming device 14 can be easily changed by changing information displayed by the display device 15. Therefore, since the display contents can be easily changed, the display plane 10 can be displayed that is easy to view and easy to operate.

As illustrated in FIG. 5, in the operation input device 1, the eyepoint position A where the eyes of the operator are located are installed in advance, and the aerial image forming device 14 is disposed on the straight line connecting the eyepoint position A and the display plane 10. Since the position of the aerial image forming device 14 is determined based on the position of the eyepoint position A and of the display plane 10, it is possible to further improve the visibility and the operability of the display plane 10.

As illustrated in FIG. 2, the length L1 of the display plane 10 in the vertical direction displayed by the aerial image forming device 14 may be shorter than the length L2 of the display plane 10 in the horizontal direction. In this case, the amount of protrusion of the operation input device 1 from the wall W can be suppressed, and a contribution is made to a reduction in the size of the operation input device 1.

The aerial image forming device 14 may display the display plane 10 such that the center 11b of each of the switches 11 is offset from the center 10b of the display plane 10. In this case, since the switches 11 are displayed on the display plane 10 with the position of each of the switches 11 biased, a region in which contents other than the switches 11 (for example, the character information 13) are displayed can be widely secured on the display plane 10. Therefore, since various contents other than the switches 11 can be displayed, the display contents of the display plane 10 can be made more substantial.

The operation input device 1 may include the notification unit 25 (notification means) that notifies the operator that the switch 11 has been operated, when the determination unit 23 determines that the switch 11 has been operated. In this case, the operator can identify an indication of execution of the operation through a notification of the operation made by the notification unit 25. Therefore, since the operator can recognize that the switch 11 has been operated, the operation input device 1 can be provided that is easier to operate.

By the way, in the related art, in a toilet or the like, since a button type switch or the like is directly pressed with a finger to operate a toilet bowl, a washlet, or the like, the operation is not hygienic, which is a problem. Particularly, in a shared toilet or the like, since a large number of unspecified people directly touch a button or the like with a finger, the above problem tends to be remarkable.

In contrast, in the operation input device 1 according to the present embodiment, the display plane 10 with the switches 11 is displayed in the air as a virtual image. Therefore, since the toilet bowl B, the washlet, or the like can be operated without directly touching a button or the like, an operation can be hygienically performed. Namely, since an operation is performed without directly touching a button or the like even in a shared toilet or the like, it is possible to provide the operation input device 1 that is good in terms of hygiene.

Initially, a language selection screen (for example, a language display screen on which Japanese, English, Chinese, or Korean can be selected) may be displayed on the display plane 10. When a language is selected on the language selection screen, a language displayed in the character information 13 may be switched to the selected language. In this case, when the operation input device 1 is disposed at an airport or the like, the operation input device 1 can be used that is multi-lingual.

The embodiment of the operation input device according to the present disclosure has been described above. However, the operation input device according to the present disclosure is not limited to the above-described embodiment and may be modified without changing the concept described in each claim or applied to other embodiments. The configurations, the shapes, the sizes, the number, the materials, and the disposition mode of the parts of the operation input device can be appropriately changed without departing from the above-described concept.

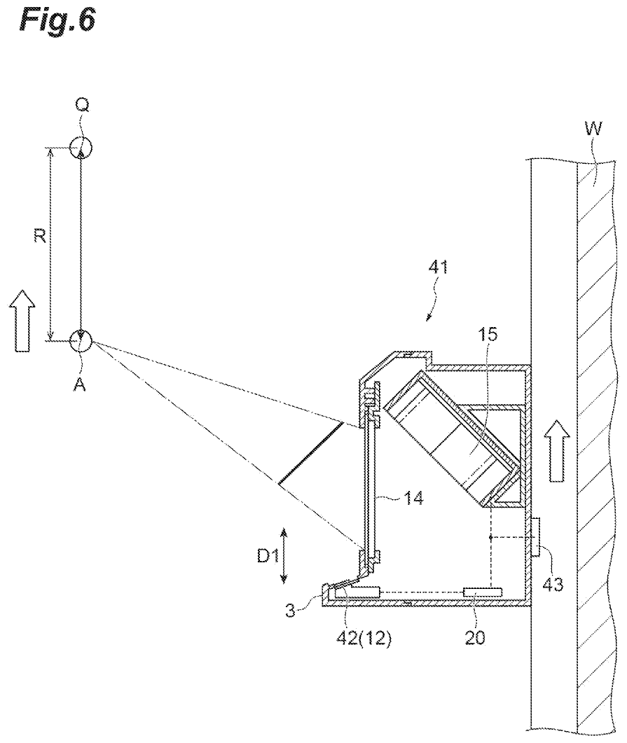

FIG. 6 is a vertical sectional view illustrating an operation input device 41 according to a modification example. The operation input device 41 includes a position detection unit 42 (position detection means) that detects a position Q of the eyes of the operator, and a movable mechanism 43 that moves the operation input device 41 along the up-down direction D1. Each of the position detection unit 42 and the movable mechanism 43 is electrically connected to, for example, the control unit 20 described above.

For example, the position detection unit 42 detects the position Q of the eyes of the operator seated in the toilet seat of the toilet T, and calculates an offset amount R between the eyepoint position A and the position Q. As one example, the position detection unit 42 is assembled into the sensor 12 described above and may be an eyeball position detection sensor that is assembled into the protrusion portion 3, together with the sensor 12. When the position detection unit 42 calculates the position Q of the eyes of the operator and the offset amount R, the position detection unit 42 outputs a detection signal to the control unit 20. When the control unit 20 receives the detection signal, the control unit 20 generates a movable signal and outputs the movable signal to the movable mechanism 43.

When the movable mechanism 43 receives the movable signal from the control unit 20, the movable mechanism 43 moves the operation input device 41 (the aerial image forming device 14 and the display device 15) along the up-down direction D1 by the offset amount R such that the eyepoint position A coincides with the position Q. In the example of FIG. 6, the position Q of the eyes of the operator detected by the position detection unit 42 is higher than the eyepoint position A determined in advance, and the operation input device 41 is moved upward such that the eyepoint position A coincides with the position Q.

The exemplary movable mechanism 43 includes a rail mechanism provided on the wall W and extending along the up-down direction D1, and a motor that generates a driving force to move the operation input device 41 along the rail mechanism. For example, when the movable mechanism 43 moves the operation input device 41 such that the eyepoint position A coincides with the position Q, the positional relationship between the eyepoint position A, the display plane 10, and the aerial image forming device 14 illustrated in FIG. 5 can be maintained.

The operation input device 41 according to the modification example includes the position detection unit 42 that detects the position Q of the eyes of the operator, and the movable mechanism 43 that moves the display device 15 and the aerial image forming device 14 such that the eyepoint position A coincides with the position Q of the eyes detected by the position detection unit 42. In this case, when the actual position Q of the eyes of the operator is different from the eyepoint position A set in advance, the movable mechanism 43 moves the eyepoint position A to the actual position Q of the eyes of the operator.

Therefore, even when the operator views the aerial image forming device 14 from a location offset from the eyepoint position A, since the eyepoint position A is moved to coincide with the actual position Q of the eyes, it is possible to provide the operation input device 41 having more improved visibility. Specifically, even when a tall adult or a child views the aerial image forming device 14 as an operator, the eyepoint position A is moved to coincide with the position Q of the eyes of the operator. As a result, the operation input device 41 can be moved to an optimal position according to the position of the eyes of the operator. The above-described configuration of the position detection unit 42 and the movable mechanism 43 is not limited to the above-described example and can be appropriately changed.

For example, instead of the movable mechanism 43 that moves the operation input device 41 along the up-down direction D1, a movable mechanism that moves the operation input device 41 along the left-right direction D2 or a movable mechanism that moves the operation input device 41 along the protruding direction D3 may be provided. The direction in which the movable mechanism moves the operation input device can be appropriately changed.

The operation input device 41 according to the modification example has been described, but the operation input device according to the present disclosure can be further modified. For example, in the above-described embodiment, the operation input device 1 provided in the toilet T has been described. However, the operation input device according to the present disclosure may be provided at a kitchen, a water supply, an ATM, a hospital, a public institution, a station, an airport, or the like.

For example, in the operation input device provided at a kitchen, the display plane with switches is displayed in the air as a virtual image, so that a cooking application can be operated without directly touching a display with a finger or the like to which ingredients are attached. In the related art, in order to touch a display of a mobile terminal or the like, hands are deliberately washed, and then a cooking application displayed on the display is operated. However, in the operation input device according to the present disclosure, since the display plane with the switches is displayed in the air as a virtual image, a cooking application can be operated by operating the switch in the air. Therefore, since the cooking application can be operated without deliberately washing hands, the operation input device having high operability can be provided.

In the operation input device provided at, for example, an ATM, a hospital, a public institution, a station, or an airport, the display plane with the switches is displayed in the air as a virtual image, so that the operation of the ATM, or a reception machine at the hospital, the airport or the like can be performed without directly touching a shared display. Therefore, since the need for contact of a finger with the shared display can be eliminated, an operation can be hygienically performed.

The operation input device provided at an airport or the like may have a fingerprint authentication function. In this case, for example, the target object detection unit 22 of the control unit 20 may detect the target object F and acquire a fingerprint image of a finger when the target object F is the finger. The control unit 20 may compare the fingerprint image acquired by the target object detection unit 22, with fingerprint images stored in advance. As described above, when the operation input device has the fingerprint authentication function, the operation input device 1 can be applied to immigration or the like.

When the operation input device has the fingerprint authentication function, for example, the control unit 20 may include a storage unit that stores fingerprint images of persons to be arrested, in advance. When the fingerprint image stored in the storage unit coincides with the fingerprint image acquired by the target object detection unit 22, the control unit 20 may output a signal indicating that a person to be arrested exists. When the police or the like receives the signal, a person to be arrested can be arrested at an airport or the like.

In the above-described embodiment, an example has been described in which the sensor 12 measures a distance between the sensor 12 and each point on an object through the light coding method, but the sensor 12 is not limited to the method. For example, the sensor 12 may measure a distance between the sensor 12 and each point on an object through the time of flight (TOF) method. In the TOF method, the sensor 12 calculates a flight time (delay time) of light rays taken until the light rays are reflected by each point on the object and then reach the sensor 12, and measures a distance between the sensor 12 and each point on the object from the calculated flight time and the speed of light. Such a form also exhibits the same effects as those of the above-described embodiment. The type of the sensor is not limited to a depth sensor. Instead of the sensor 12 that is a depth sensor, an infrared sensor, an ultrasonic sensor, or the like may be provided, and the type of the sensor can be appropriately changed.

In the above-described embodiment, an example has been described in which the plurality of switches 11 are disposed at a lower portion to be arranged in the horizontal direction and the aerial image forming device 14 and the display device 15 display the display plane 10 in which the character information 13 is displayed above the switches 11. However, the layout of the switches and the like on the display plane is not limited to the above example and can be appropriately changed.

### REFERENCE SIGNS LIST

1, 41: operation input device, 2: housing, 2b: front surface, 2c: side surface, 2d: upper surface, 2f: lower surface, 2g: support portion, 2h: first plate portion, 2j: second plate portion, 3: protrusion portion, 3b: main surface, 3c: end surface, 3d: back surface, 10: display plane, 10b: center, 11: switch, 11b: center, 12: sensor, 13: character information, 14: aerial image forming device, 15: display device, 15b: screen, 20: control unit, 21: image output unit, 22: target object detection unit, 23, determination unit, 24: signal output unit, 25: notification unit, 25b: audio output unit, 25c: color changing unit, 30: device control unit, 42: position detection unit (position detection means), 43: movable mechanism, A: eyepoint position, B: toilet bowl, C: light, D1: up-down direction, D2: left-right direction, D3: protruding direction, E: toilet paper, F: target object, K: distance, M: washbasin, O: origin, Q: position, R: offset amount, T: toilet, V: reference line, W: wall, Y: threshold value, Z: press determination plane.

1. An operation input device comprising:
a display device that emits light to display information;
an aerial image forming device that reflects the light from the display device a plurality of times to display a display plane with a switch in an air as a virtual image;
a sensor that detects a position of a target object approaching the switch; and
a determination unit that determines whether or not the switch has been operated, based on the position of the target object detected by the sensor,
wherein an eyepoint position where eyes of an operator that operates the switch are located is set in advance, and
the aerial image forming device is disposed on a straight line connecting the eyepoint position and the display plane.

2. The operation input device according to claim 1,
wherein a length of the display plane in a vertical direction displayed by the aerial image forming device is shorter than a length of the display plane in a horizontal direction.

3. The operation input device according to claim 1,
wherein the aerial image forming device displays the display plane such that a center of the switch is offset from a center of the display plane.

4. The operation input device according to claim 1, further comprising:
a notifier for notifying the operator that the switch has been operated, when the determination unit determines that the switch has been operated.

5. The operation input device according to claim 1, further comprising:
a position detector for detecting a position of the eyes of the operator; and
a movable mechanism that moves the display device and the aerial image forming device such that the eyepoint position coincides with the position of the eyes detected by the position detector.
